(19) United States
(12) Patent Application Publication
(10) Pub. No.: US 2025/0333290 A1
(43) Pub. Date: Oct. 30, 2025

(54) Gasoline Transfer System

(71) Applicant: Tilford Loy, Columbia, KY (US)

(72) Inventor: Tilford Loy, Columbia, KY (US)

(21) Appl. No.: 18/649,369

(22) Filed: Apr. 29, 2024

(51) Int. Cl. B67D 7/04; B67D 7/00; B67D 7/38

(52) U.S. Cl. CPC B67D 7/04; B67D 7/007; B67D 7/38

(57) ABSTRACT

A gasoline transfer system generally includes a gasoline diverter assembly, a transfer assembly, and a coupling. The gasoline diverter assembly is mounted in a fueled vehicle and includes a conduit operatively connected to a fuel system of the fueled vehicle. The transfer assembly is designed to conduct gasoline diverted from the fueled vehicle to a fuel-deficient vehicle, wherein the transfer assembly includes a hose having a first end operatively connected to the gasoline diverter assembly and a second end insertable into a filler pipe of a fuel-deficient vehicle. The coupling includes a first member attached to the first end of the hose and a second member mounted in a wall of the fueled vehicle and detachably connected to the first member, wherein the second member is connected to the conduit.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to fuel siphoning devices and more particularly pertains to a new gasoline transfer system for safely and cleanly transferring gasoline from one vehicle to another, such as from one automobile to another. It should be understood that while gasoline is specifically referred to herein to describe an embodiment of the disclosure, the embodiment is equally useful for all types of liquid fuels, including both gasoline and diesel fuels.

### (2) Description of Related Art Including Information Disclosed Under 37 CFR 1.97 and 1.98

The prior art relates to fuel siphoning devices. The prior art, as best understood, does not disclose an integrated gasoline transfer system that includes a gasoline diverter assembly and a transfer assembly to conduct gasoline from a fueled vehicle to a fuel deficient vehicle.

### BRIEF SUMMARY OF THE INVENTION

An embodiment of the disclosure meets the needs presented above in a gasoline transfer system generally comprising a gasoline diverter assembly, a transfer assembly, and a coupling. The gasoline diverter assembly is mounted in a fueled vehicle and includes a conduit operatively connected to a fuel system of the fueled vehicle. The transfer assembly is designed to conduct gasoline diverted from the fueled vehicle to a fuel-deficient vehicle, wherein the transfer assembly includes a hose having a first end operatively connected to the gasoline diverter assembly and a second end insertable into a filler pipe of a fuel-deficient vehicle. The coupling includes a first member attached to the first end of the hose and a second member mounted in a wall of the fueled vehicle and detachably connected to the first member, wherein the second member is connected to the conduit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a side view of a gasoline transfer system according to an embodiment of the disclosure.

FIG. 2 is a side view of an embodiment of the disclosure.

FIG. 3 is a side view of a gasoline transfer system according to an alternative embodiment of the disclosure.

FIG. 4 is a perspective view of a portion of an embodiment of the disclosure.

FIG. 5 is a side view of an embodiment of the disclosure in use.

### DETAILED DESCRIPTION OF THE INVENTION

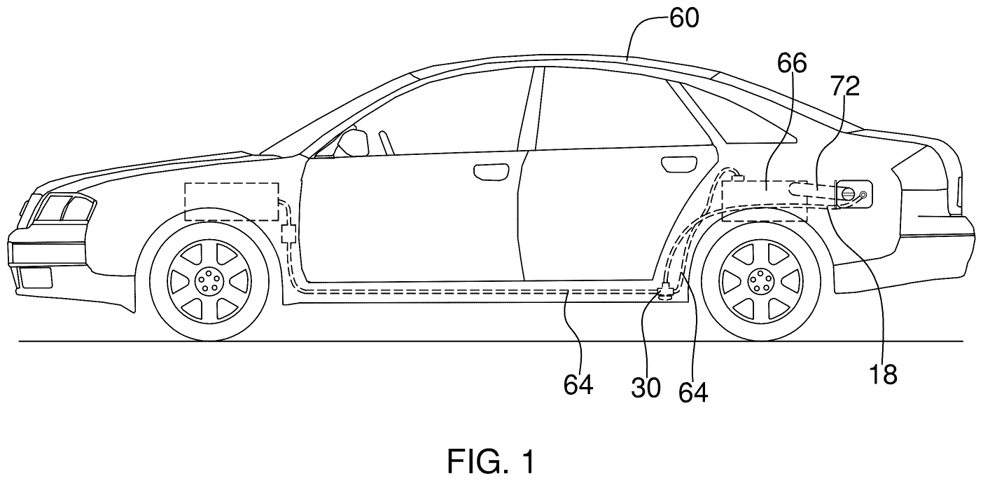

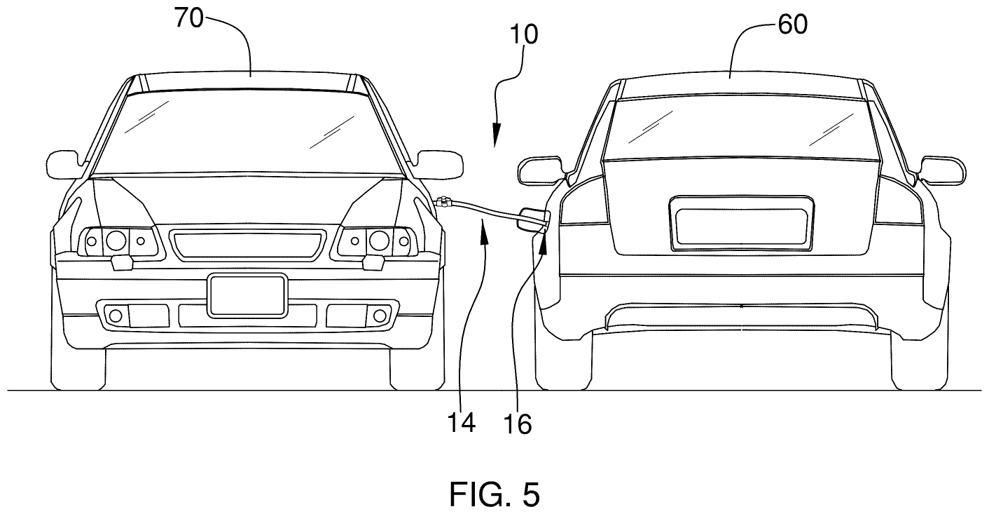

With reference now to the drawings, and in particular to FIGS. 1 through 5 thereof, a new gasoline transfer system embodying the principles and concepts of an embodiment of the disclosure and generally designated by the reference numeral 10 will be described.

As best illustrated in FIGS. 1 through 5, the gasoline transfer system 10 generally comprises a gasoline diverter assembly 12, a transfer assembly 14, and a coupling 16. The gasoline diverter assembly 12 is mounted in a fueled vehicle 60 and includes a conduit 18 operatively connected to a fuel system of the fueled vehicle 60. The transfer assembly 14 is designed to conduct gasoline diverted from the fueled vehicle 60 to a fuel-deficient vehicle 70, wherein the transfer assembly 14 includes a hose 20 having a first end 22 operatively connected to the gasoline diverter assembly 12 and a second end 24 insertable into a filler pipe 72 of a fuel-deficient vehicle 70. The coupling 16 includes a first member 26 attached to the first end 22 of the hose 20 and a second member 28 mounted in a wall 62 of the fueled vehicle 60 and detachably connected to the first member 26, wherein the second member 28 is connected to the conduit 18.

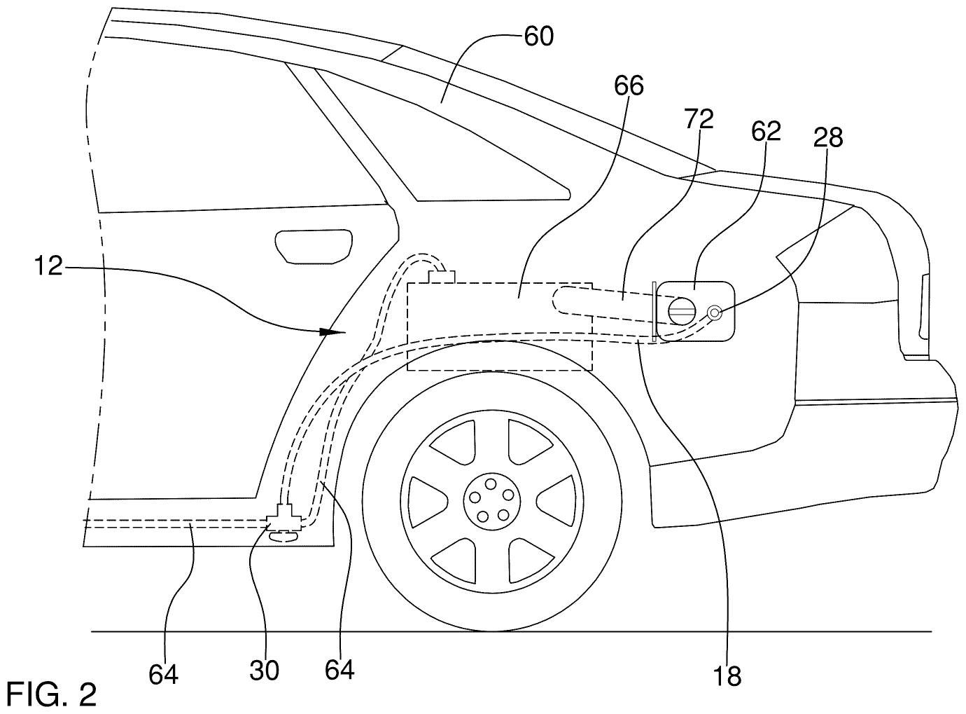

In an exemplary embodiment shown in FIGS. 1 and 2, the gasoline diverter assembly 12 includes a T-valve 30 interposed between two sections of a fuel line 64 of the fueled vehicle 60 and connected to the conduit 18 to permit diversion of a portion of gasoline pumped through the fuel line 64 into the conduit 18. The T-valve 30 could be openable to permit diversion of gasoline into the conduit 18 and closable to prevent diversion of gasoline into the conduit 18.

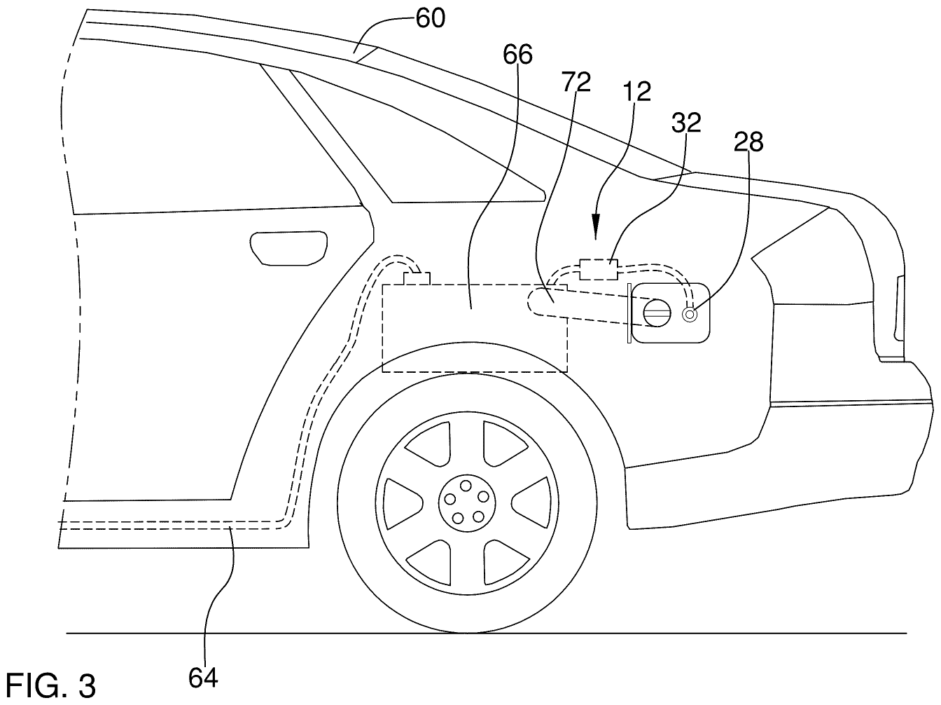

In an alternative exemplary embodiment shown in FIG. 3, instead of using a T-valve 30 connected to the fuel line 64, the gasoline diverter assembly 12 includes a fuel pump 32 connecting a fuel tank 66 of the fueled vehicle 60 to the conduit 18 and actuatable to pump gasoline into and through the conduit 18 to the first member 26.

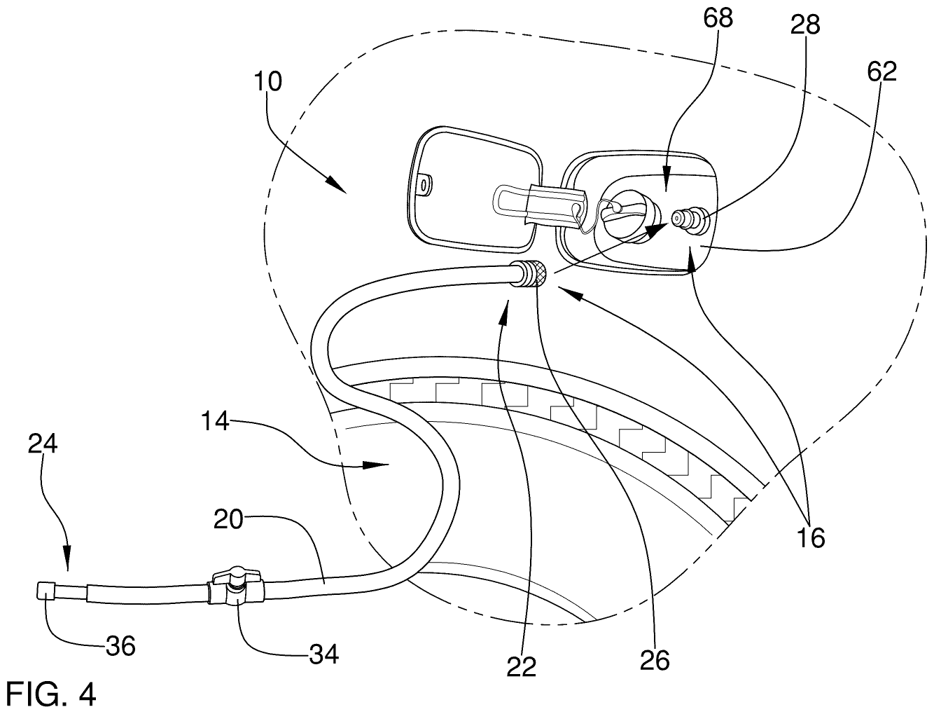

As shown in FIG. 4, the transfer assembly 14 includes a valve 34 interposed between two sections of the hose 20 and is openable and closable to permit and prevent flow of gasoline through the hose 20. In one possible embodiment, the valve 34 is positioned at the second end 24 of the hose 20 and comprises an automatic shut-off valve to sense and prevent over-filling of the gas tank of a fuel-deficient vehicle 70.

The transfer assembly 14 also includes an end cap 36 to cover and close the second end 24, such as when it is not in use. The second end 24 includes a portion of the hose 20 having a smaller diameter than other portions of the hose 20 to permit insertion into a filler pipe of a fuel-deficient vehicle 70. Each of the first member 26 and the second member 28 is designed as a quick connect fitting. For example, in the exemplary embodiment shown in FIG. 4, the first member 26 could be a male quick connect fitting and the second member 28 could be a female quick connect fitting, such that fuel only flows out through said first member 26 when it is connected to the second member 28. The second member 28 is mounted in a gas cap compartment 68 adjacent a mouth of a filler pipe 72 of the fueled vehicle 60.

To use the gasoline transfer system 10, a user positions the fueled vehicle 60 next to or adjacent the fuel-deficient vehicle 70. The user then connects the first member 26 attached to the first end 22 of the hose 20 to the second member 28 mounted on the fueled vehicle 60. The user then places the second end 24 of the hose 20 into the filler pipe of a fuel-deficient vehicle 70. The user then places the key in the ignition of the fueled vehicle 60 and turns it into the “on” position to activate the primary fuel pump in the fuel tank 66. If the user is using the embodiment of the gasoline diverter assembly 12 that includes a T-valve 30 built into the fuel line 64, the primary fuel pump causes fuel to flow into the conduit 18. If the user is using the embodiment of the gasoline diverter assembly 12 shown in FIG. 3, the fuel pump 32 of that embodiment is also activated to draw fuel out of the fuel tank 66. Gasoline or diesel fuel is then conducted into the conduit 18, through the coupling 16, through the hose 20, and then into the fuel-deficient vehicle 70. In this manner the user can add some fuel from one vehicle to another without the need for fuel canisters or gas cans. It should be noted that the gasoline transfer system 10 could be used to transfer fuel into any fuel reservoir, whether it is part of a vehicle, another type of machine, or a fuel storage container.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A gasoline transfer system comprising:
a gasoline diverter assembly mounted in a fueled vehicle and comprising a conduit operatively connected to a fuel system of said fueled vehicle;
a transfer assembly to conduct gasoline diverted from said fueled vehicle to a fuel-deficient vehicle, wherein said transfer assembly comprises a hose having a first end operatively connected to said gasoline diverter assembly and a second end insertable into a filler pipe of a fuel-deficient vehicle; and
a coupling comprising a first member attached to said first end of said hose and a second member mounted in a wall of said fueled vehicle and detachably connected to said first member, wherein said second member is connected to said conduit.

2. The gasoline transfer system of claim 1, wherein said gasoline diverter assembly comprises a T-valve interposed between two sections of a fuel line of said fueled vehicle and connected to said conduit to permit diversion of a portion of gasoline pumped through said fuel line into said conduit.

3. The gasoline transfer system of claim 2, wherein said T-valve is openable to permit diversion of gasoline into said conduit and closable to prevent diversion of gasoline into said conduit.

4. The gasoline transfer system of claim 3, wherein said transfer assembly comprises a valve interposed between two sections of said hose and being openable and closable to permit and prevent flow of gasoline through said hose.

5. The gasoline transfer system of claim 3, wherein said transfer assembly comprises an end cap to cover and close said second end.

6. The gasoline transfer system of claim 3, wherein said second end comprises a portion of said hose having a smaller diameter than other portions of said hose to permit insertion into a filler pipe of a fuel-deficient vehicle.

7. The gasoline transfer system of claim 3, wherein each of said first member and said second member comprises a quick connect fitting.

8. The gasoline transfer system of claim 3, wherein said second member is mounted in a gas cap compartment adjacent a mouth of a filler pipe of said fueled vehicle.

9. The gasoline transfer system of claim 1, wherein said gasoline diverter assembly comprises a fuel pump connecting a fuel tank of said fueled vehicle to said conduit and actuatable to pump gasoline into and through said conduit to said first member.

10. The gasoline transfer system of claim 9, wherein said transfer assembly comprises a valve interposed between two sections of said hose and being openable and closable to permit and prevent flow of gasoline through said hose.

11. The gasoline transfer system of claim 9, wherein said transfer assembly comprises an end cap to cover and close said second end.

12. The gasoline transfer system of claim 9, wherein said second end comprises a portion of said hose having a smaller diameter than other portions of said hose to permit insertion into a filler pipe of a fuel-deficient vehicle.

13. The gasoline transfer system of claim 9, wherein each of said first member and said second member comprises a quick connect fitting.

14. The gasoline transfer system of claim 9, wherein said second member is mounted in a gas cap compartment adjacent a mouth of a filler pipe of said fueled vehicle.

15. A gasoline transfer system comprising:
a gasoline diverter assembly mounted in a fueled vehicle and comprising a conduit operatively connected to a fuel system of said fueled vehicle, wherein one of (A) and (B):
(A) said gasoline diverter assembly comprises a T-valve interposed between two sections of a fuel line of said fueled vehicle and connected to said conduit to permit diversion of a portion of gasoline pumped through said fuel line into said conduit, and said T-valve is openable to permit diversion of gasoline into said conduit and closable to prevent diversion of gasoline into said conduit, and
(B) said gasoline diverter assembly comprises a fuel pump connecting a fuel tank of said fueled vehicle to said conduit and actuatable to pump gasoline into and through said conduit to said first member;
a transfer assembly to conduct gasoline diverted from said fueled vehicle to a fuel-deficient vehicle, wherein said transfer assembly comprises a hose having a first end operatively connected to said gasoline diverter assembly and a second end insertable into a filler pipe of a fuel-deficient vehicle, wherein:
said transfer assembly comprises a valve interposed between two sections of said hose and being openable and closable to permit and prevent flow of gasoline through said hose, and
said transfer assembly comprises an end cap to cover and close said second end,
said second end comprises a portion of said hose having a smaller diameter than other portions of said hose to permit insertion into a filler pipe of a fuel-deficient vehicle; and
a coupling comprising a first member attached to said first end of said hose and a second member mounted in a wall of said fueled vehicle and detachably connected to said first member, wherein said second member is connected to said conduit, wherein:
each of said first member and said second member comprises a quick connect fitting, and
said second member is mounted in a gas cap compartment adjacent a mouth of a filler pipe of said fueled vehicle.
